(19) United States
(12) Patent Application Publication
(10) Pub. No.: US 2021/0310450 A1
(43) Pub. Date: Oct. 7, 2021

(54) INTAKE-AIR COOLING SYSTEM

(71) Applicant: Mazda Motor Corporation, Aki-gun (JP)

(72) Inventors: Kazuaki Narahara, Aki-gun (JP); Kota Maekawa, Aki-gun (JP); Chinami Morishima, Aki-gun (JP); Masaharu Marumoto, Aki-gun (JP); Tohru Hokazono, Aki-gun (JP)

(21) Appl. No.: 17/193,252

(22) Filed: Mar. 5, 2021

(30) Foreign Application Priority Data
Apr. 3, 2020 (JP) 2020-067583

(51) Int. Cl. F02M 31/20; F02B 63/06; F02M 35/10; F02D 41/00

(52) U.S. Cl. CPC F02M 31/205; F02D 41/0002; F02M 35/10242; F02B 63/06

(57) ABSTRACT

An intake-air cooling system configured to cool intake air of a vehicle engine is provided, which includes an intake passage, a compressor, an evaporator, and a controller. The intake passage branches to first and second intake passages and is provided with a damper configured to change a ratio between air flow rates flowing into the first and second intake passages. The evaporator is provided to the second intake passage and cools the air flowing therethrough. When the controller does not determine that the engine driving state belongs to a knock occurring range, the controller controls the compressor so that a flow rate of refrigerant supplied to the evaporator becomes smaller within a range larger than zero, and controls the damper so that the ratio of the flow rate of the air flowing into the second intake passage becomes smaller, than a case the state belongs to the knock occurring range.

### TECHNICAL FIELD

The present disclosure relates to an intake-air cooling system which cools intake air of a vehicle engine.

### BACKGROUND OF THE DISCLOSURE

A technology for suppressing a knock by cooling air supplied to a combustion chamber of an engine (hereinafter, “intake air”) is known. For example, JP2009-236083A discloses an intake-air cooling device which cools intake air flowing through an intake passage by using an evaporator. In the intake-air cooling device, a compressor compresses refrigerant by being driven by the engine and the refrigerant is supplied to the evaporator. In this device, by supplying the refrigerant to the evaporator also under conditions where a knock does not occur to precool the evaporator, the response when starting intake-air cooling thereafter is improved.

In this intake air cooling device, intake air always passes through the evaporator while the engine is driven, and therefore, heat is exchanged in the evaporator. Therefore, in order to precool the evaporator and to maintain the precooled state, there is a problem in which a comparatively large amount of refrigerant needs to be supplied continuously to the evaporator, and as a result, drag applied to the engine increases.

### SUMMARY OF THE DISCLOSURE

The present disclosure is made in view of the above situation, and one purpose thereof is to provide an intake-air cooling system which can suppress an engine drag which originates in precooling of the evaporator.

According to one aspect of the present disclosure, an intake-air cooling system configured to cool intake air of an engine of a vehicle is provided, which includes an intake passage configured to supply air to a combustion chamber of the engine, a compressor coupled to an output shaft of the engine and configured to be driven by rotation of the output shaft to discharge refrigerant, an evaporator provided to the intake passage and configured to exchange heat between the refrigerant supplied from the compressor and the air flowing through the intake passage to cool the air, and a controller configured to determine whether a driving state of the engine belongs to a knock occurring range where a knock tends to occur, and control the compressor. The intake passage branches to a first intake passage and a second intake passage, and is provided with a damper configured to change a ratio between a flow rate of air flowing into the first intake passage and a flow rate of air flowing into the second intake passage. The evaporator is provided to the second intake passage and cools the air flowing through the second intake passage. When the controller does not determine that the driving state of the engine belongs to the knock occurring range, the controller controls the compressor so that a flow rate of the refrigerant supplied to the evaporator becomes smaller within a range larger than zero, and controls the damper so that the ratio of the flow rate of the air flowing into the second intake passage becomes smaller than in a case where the controller determines that the driving state of the engine belongs to the knock occurring range.

According to this configuration, the evaporator is provided to the second intake passage among the first intake passage and the second intake passage which supply the air to the combustion chamber of the engine. Further, when the driving state of the engine does not belong to the knock occurring range (i.e., when the cooling of intake air is not required), the refrigerant discharged from the compressor is supplied to the evaporator to precool the evaporator.

At this time, since a ratio of the flow rate of the air which flows into the second intake passage is smaller than that when the driving state of the engine belongs to the knock occurring range (i.e., when the cooling of intake air is required), the heat exchange between the refrigerant and the air in the evaporator becomes slower. Therefore, only by supplying the refrigerant to the evaporator at a comparatively small flow rate, the evaporator can be precooled to maintain the precooled state. As a result, it becomes possible to suppress the drag applied to the engine because of the precooling of the evaporator.

The controller may acquire a temperature of the evaporator and a temperature of air around the evaporator and estimate an amount of dew condensation water adhering to an outer surface of the evaporator. If the controller determines that the amount of dew condensation water is equal to or great than a given amount, the controller may control the damper so that the ratio of the flow rate of the air flowing into the second intake passage becomes larger than a case where the controller does not determine that the amount of dew condensation water is equal to or greater than the given amount.

According to the heat exchange in the evaporator, the dew condensation water may adhere to the outer surface of the evaporator, and the dew condensation water may flow into the combustion chamber of the engine along with air. If the amount of dew condensation water that flows into the combustion chamber at once is small, since the dew condensation water evaporates in the combustion chamber and is discharged, it will not cause trouble for the engine. However, if a large amount of dew condensation water flows into the combustion chamber at once, the water hammer phenomenon occurs, which may lead to damage to the engine.

Therefore, according to this configuration, when it is determined that the amount of dew condensation water adhering to the outer surface of the evaporator is equal to or greater than the given amount, the ratio of the flow rate of the air which flows into the second intake passage is relatively increased. The “given amount” is set so that, even if the amount of the dew condensation water flows into the combustion chamber at once, this dew condensation water does not cause trouble for the engine, and thus, it becomes possible to process the dew condensation water safely by positively causing the dew condensation water to flow into the combustion chamber due to the air which flows through the second intake passage at the comparatively high flow rate. That is, it becomes possible to prevent damage to the engine by processing the dew condensation water while the amount of dew condensation water is comparatively small.

When the temperature of the evaporator is equal to or less than a given temperature and fuel is supplied to the combustion chamber of the engine, the controller may control the compressor so that the flow rate of the refrigerant supplied to the evaporator reaches a first flow rate. When the temperature of the evaporator is equal to or less than the given temperature and the vehicle travels without the fuel being supplied to the combustion chamber of the engine, the controller may control the compressor so that the flow rate of the refrigerant supplied to the evaporator reaches a second flow rate larger than the first flow rate.

According to this configuration, when the temperature of the evaporator is equal to or less than the given temperature, and the fuel is supplied to the combustion chamber of the engine, it becomes possible to suppress the drag applied to the engine by relatively reducing the flow rate of the refrigerant supplied to the evaporator and suppressing the excessive precooling of the evaporator. In this case “the flow rate of the refrigerant supplied to the evaporator” is a value including zero.

On the other hand, when the vehicle travels without the fuel being supplied to the combustion chamber of the engine (i.e., when the vehicle travels only by inertia), it is possible to drive the compressor coupled to the output shaft of the engine by using the kinetic energy of the vehicle. Therefore, in this case, even if the temperature of the evaporator is equal to or less than the given temperature, it becomes possible to precool the evaporator sufficiently by using the kinetic energy of the vehicle and relatively increasing the flow rate of the refrigerant supplied to the evaporator.

The damper may be an instrument configured to change the directivity of the intake air, and may be controlled, by an actuator configured to be driven based on a control signal, so that the damper pivots to a position between a first position and a second position.

When the damper is located at the first position, the first intake passage may be opened and the second intake passage may be closed by the damper. When the damper is located at the second position, the first intake passage may be closed and the second intake passage may be opened by the damper.

When the controller does not determine that the driving state of the engine belongs to the knock occurring range, the damper may be disposed at the first position.

When the controller determines that the driving state of the engine belongs to the knock occurring range, the damper may be disposed at the second position.

### BRIEF DESCRIPTION OF DRAWINGS

FIG. 1 is a schematic view of a vehicle on which an intake-air cooling system according to one embodiment is mounted.

FIG. 2 is a time chart illustrating one example of operation of the cooling system and an air-conditioner.

FIG. 3 is a flowchart illustrating processing executed by a controller.

FIG. 4 is a flowchart illustrating processing executed by the controller.

FIG. 5 is a flowchart illustrating processing executed by the controller.

### DETAILED DESCRIPTION OF THE DISCLOSURE

Hereinafter, an intake-air cooling system 1 according to one embodiment is described with reference to the accompanying drawings.

### <Vehicle>

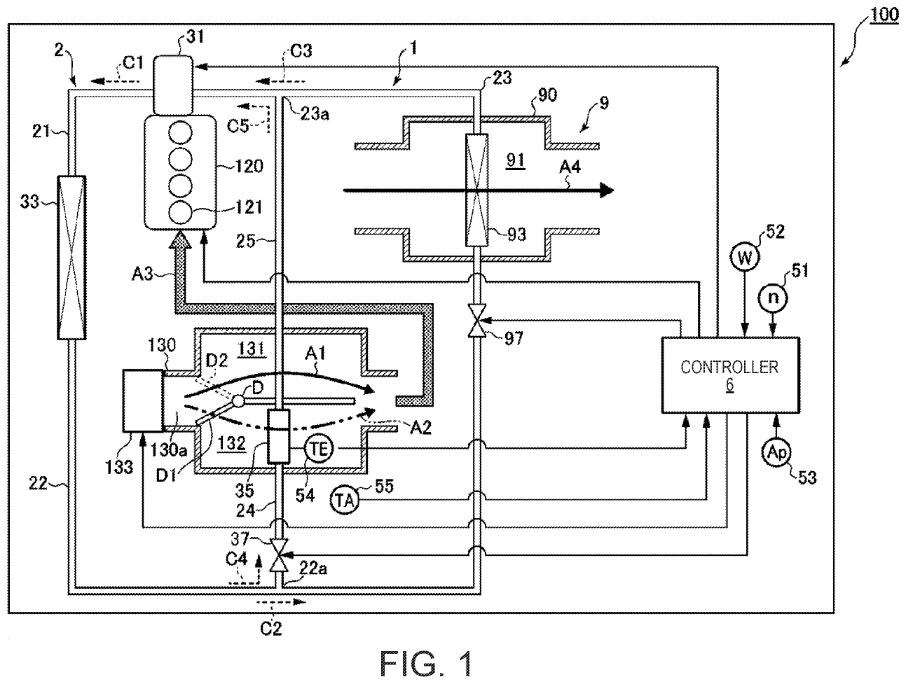

First, a vehicle 100 on which the intake-air cooling system 1 according to this embodiment is mounted is described with reference to FIG. 1. FIG. 1 is a schematic view of the vehicle 100 on which the intake-air cooling system 1 is mounted.

An engine 120 is accommodated in an engine bay of the vehicle 100. The engine 120 is an internal combustion engine having a plurality of combustion chambers 121, which combusts fuel injected into the combustion chambers 121 from injectors (not illustrated) to generate torque. The torque generated by the engine 120 is transmitted from an output shaft (not illustrated) of the engine 120 to wheels (not illustrated) through a powertrain (not illustrated) to be used for propelling the vehicle 100 and also used for driving a compressor 31 (described later).

An intake duct 130 is disposed in the engine bay, and an intake passage 130a is formed inside the intake duct 130. Negative pressure generated in the combustion chambers 121 of the engine 120 draws air (hereinafter, “intake air”) from outside of the vehicle 100 into the intake passage 130a. A temperature TA of the intake air taken into the intake passage 130a is detected by a temperature sensor 55 provided near the intake duct 130.

The intake passage 130a branches at location downstream of a throttle valve 133 to a first intake passage 131 and a second intake passage 132. An evaporator 35 for intake air (described later) is provided to the second intake passage 132, and intake air flows in the second intake passage 132 so that it passes through the intake evaporator 35. The first intake passage 131 is connected to a part of the second intake passage 132 downstream of the intake evaporator 35. That is, the first intake passage 131 is a bypass passage where intake air flows without passing through the intake evaporator 35.

A damper D is provided to a part of the intake passages 130a downstream of the throttle valve 133 and upstream of the first intake passage 131 and the second intake passage 132. The damper D is an instrument for changing the directivity of intake air. The damper D is pivotable within a given range by an actuator (not illustrated) which is driven based on a control signal. In detail, the damper D is pivotable between a first position D1 illustrated by the solid line and a second position D2 illustrated by the broken line.

When the damper D is located at the first position D1, the first intake passage 131 is opened and the second intake passage 132 is closed by the damper D. Therefore, all the intake air which passed through the throttle valve 133 flows to pass through the first intake passage 131 as illustrated by an arrow A1.

Moreover, when the damper D is located at the second position D2, the first intake passage 131 is closed by the damper D and the second intake passage 132 is opened. Therefore, all the intake air which passed through the throttle valve 133 flows to pass through the second intake passage 132 as illustrated by an arrow A2.

Further, the damper D can stop at arbitrary positions between the first position D1 and the second position D2. Therefore, a portion of the intake air which passed through the throttle valve 133 can flow into the first intake passage 131, and the remaining intake air can flow into the second intake passage 132. By changing the position of the damper D, a ratio of a flow rate of the intake air which flows into the first intake passage 131 and a flow rate of the intake air which flows into the second intake passage 132 can be adjusted. The intake air which passed through the first intake passage 131 and/or the second intake passage 132 is supplied to the combustion chambers 121 of the engine 120, as illustrated by an arrow A3.

An operator of the vehicle 100 adjusts torque generated by the engine 120 by stepping on an accelerator pedal (not illustrated). When a stepping-on amount of the accelerator pedal changes, an amount of fuel injected from the injector and an amount of intake air which passes through the throttle valve 133 change so that combustion of fuel inside the combustion chambers 121 is adjusted.

### <Configuration of Air-Conditioner>

An air-conditioner 9 is mounted on the vehicle 100. The air-conditioner 9 adjusts temperature inside a cabin of the vehicle 100. The operator of the vehicle 100 operates switches (not illustrated) provided in the cabin to start/end operation of the air-conditioner 9, or to set a target temperature of the cabin. The air-conditioner 9 is provided with a refrigerant passage 2 and a casing 90. Moreover, the air-conditioner 9 includes the compressor 31 provided to the refrigerant passage 2, a condenser 33, an evaporator 93 for air conditioning (A/C evaporator), and an expansion valve 97 for air conditioning (A/C expansion valve). A part of the configuration is also used by the intake-air cooling system 1, as will be described later.

Refrigerant flows and circulates inside the refrigerant passage 2. The refrigerant passage 2 includes a first refrigerant passage 21, a second refrigerant passage 22, and a third refrigerant passage 23. The first refrigerant passage 21 supplies refrigerant discharged from the compressor 31 to the condenser 33. The second refrigerant passage 22 supplies refrigerant which passed through the condenser 33 to the A/C evaporator 93 through the A/C expansion valve 97. The third refrigerant passage 23 supplies refrigerant which passed through the A/C evaporator 93 to the compressor 31.

The casing 90 is a case of the air-conditioner 9, where a passage 91 for air conditioning (A/C passage) is formed therein. When a blower (not illustrated) which is an air blower device of the air-conditioner 9 is driven, air flows through the A/C passage 91, as illustrated by an arrow A4. This air is suitably heated by a heater (not illustrated), and it is blown to a windshield of the cabin, the operator's face, and the operator's feet to be used for adjustment of the cabin temperature.

The compressor 31 is coupled to the output shaft of the engine 120. The compressor 31 is driven based on rotation of the output shaft, and it compresses and discharges the refrigerant. The compressor 31 has a clutch (not illustrated) therein, and the clutch is controlled based on a control signal. A discharge pressure of the compressor 31 is adjustable by changing the control signal transmitted to the clutch.

The condenser 33 is a heat exchanger disposed near a grille of the vehicle 100. The grille is an opening formed in a front end of the vehicle 100. The condenser 33 is disposed so that air which flows into the engine bay from the grille flows along an outer surface of the condenser 33. A passage is formed inside the condenser 33, and refrigerant supplied from the first refrigerant passage 21 passes through the passage and is discharged into the second refrigerant passage 22.

The A/C evaporator 93 is a heat exchanger which is provided to the A/C passage 91. The A/C evaporator 93 is connected to the second refrigerant passage 22 and the third refrigerant passage 23. A passage (not illustrated) where refrigerant flows is formed inside the A/C evaporator 93. The A/C evaporator 93 exchanges heat between air flowing along the outer surface of the A/C evaporator 93 and refrigerant flowing through the internal passage.

The A/C expansion valve 97 is an electromagnetic valve where a valve body (not illustrated) changes its posture based on a control signal. The A/C expansion valve 97 is provided to the second refrigerant passage 22, and is changeable of its opening between a fully-closed state and a fully-opened state.

### <Configuration of Intake-Air Cooling System>

The intake-air cooling system 1 is mounted on the vehicle 100 for the purpose of suppressing a knock of the engine 120. In detail, the intake-air cooling system 1 is mounted in order to cool intake air which flows through the intake passage 130a and accordingly to reduce combustion temperature of fuel inside the combustion chambers 121.

The intake-air cooling system 1 includes the compressor 31, the condenser 33, a fourth refrigerant passage 24, a fifth refrigerant passage 25, the intake evaporator 35, an intake expansion valve 37, and a controller 6.

The fourth refrigerant passage 24 and the fifth refrigerant passage 25 are a part of the refrigerant passages 2. The fourth refrigerant passage 24 supplies to the intake evaporator 35 refrigerant which inflows from a branch part 22a of the second refrigerant passage 22 provided upstream of the A/C expansion valve 97. The fifth refrigerant passage 25 supplies refrigerant which passed through the intake evaporator 35 to a joining part 23a provided to the third refrigerant passage 23. That is, the fourth refrigerant passage 24 and the fifth refrigerant passage 25 are bypass passages where refrigerant flows from the second refrigerant passage 22 to the third refrigerant passage 23 while bypassing the A/C evaporator 93 and the A/C expansion valve 97.

The intake evaporator 35 is a heat exchanger, and is one example of an “evaporator” according to the present disclosure. The intake evaporator 35 is provided to the second intake passage 132, and is connected to the fourth refrigerant passage 24 and the fifth refrigerant passage 25. A passage (not illustrated) where refrigerant flows is formed inside the intake evaporator 35. The intake evaporator 35 exchanges heat between intake air flowing along an outer surface of the intake evaporator 35 and refrigerant flowing through an internal passage. A temperature TE of the outer surface of the intake evaporator 35 is detected by a temperature sensor 54.

The intake expansion valve 37 is an electromagnetic valve, where a valve body (not illustrated) changes its posture based on a control signal. An opening of the intake expansion valve 37 is changeable between a fully-closed state and a fully-opened state.

The controller 6 is an electronic control unit which is comprised of devices such as a processor and memory (not illustrated). The controller 6 receives detection signals from an engine speed sensor 51, a wheel speed sensor 52, an accelerator opening sensor 53, the temperature sensor 54, and the temperature sensor 55. The controller 6 performs a given calculation based on each detection signal to acquire information, such as an engine speed of the engine 120, a rotating speed of wheel(s), an opening of the throttle valve 133 based on depression of the accelerator pedal, the temperature TE of the outer surface of the intake evaporator 35, and the temperature TA of intake air taken into the intake passage 130a.

Moreover, the controller 6 generates a control signal and a request signal based on the acquired information. The controller 6 controls each element by transmitting the control signal and request signal to the compressor 31, the intake expansion valve 37, the A/C expansion valve 97, the engine 120, the throttle valve 133, and the damper D.

Moreover, the controller 6 determines, based on the acquired information, to which occurring range (a “knock occurring range” or a “non-knock occurring range”) the driving state of the engine 120 when the information is acquired belongs. Here, the “knock occurring range” is a driving state where a knock of the engine 120 occurs comparatively easily, and the “non-knock occurring range” is a driving state where a knock of the engine 120 does not occur easily as compared with the “knock occurring range.” The memory of the controller 6 stores a map for defining the “knock occurring range” and the “non-knock occurring range” based on a required torque to the engine 120, the engine speed, etc. The controller 6 performs the determination described above by calculating the required torque to the engine 120 when the information is acquired, and referring to the map based on the calculated value and the engine speed when the information is acquired.

Moreover, the controller 6 estimates an amount DW of dew condensation water adhering to the outer surface of the intake evaporator 35 based on the acquired information. In detail, the controller 6 first calculates a saturated steam pressure of intake air by referring to the map stored in the memory based on the intake air temperature TA. Then, the controller 6 estimates the amount DW of dew condensation water adhering to the outer surface of the intake evaporator 35 based on the calculated saturated steam pressure and the temperature TE of the outer surface of the intake evaporator 35.

### <Operation of Air-Conditioner>

First, fundamental operation of the air-conditioner 9 is described. When the operator of the vehicle 100 instructs an activation to the air-conditioner 9, the compressor 31 and the blower operate and the A/C expansion valve 97 become in an opened state.

The compressor 31 is driven based on the rotation of the output shaft of the engine 120 to compress refrigerant in gaseous phase and discharge it to the first refrigerant passage 21 as illustrated by an arrow C1. The refrigerant becomes in liquid phase by being compressed in the compressor 31, and the temperature and the pressure increase.

The refrigerant in liquid phase discharged from the compressor 31 is then supplied to the condenser 33. The refrigerant is cooled by carrying out the heat exchange with air which inflows from the grille and flows along the outer surface of the condenser 33 when flowing through the passage inside the condenser 33. The refrigerant which passed through the passage inside the condenser 33 is discharged into the second refrigerant passage 22.

Since the A/C expansion valve 97 is in the opened state, the refrigerant which flows through the second refrigerant passage 22 passes through the branch part 22a and flows into the A/C expansion valve 97 side, as illustrated by an arrow C2. The refrigerant expands when passing through the A/C expansion valve 97, and its temperature decreases.

The low-temperature refrigerant which passed through the A/C expansion valve 97 is then supplied to the A/C evaporator 93. The refrigerant evaporates by carrying out the heat exchange with air which is blown off from the blower (not illustrated) of the air-conditioner 9 and flows along the outer surface of the A/C evaporator 93, when flowing through the passage inside the A/C evaporator 93. That is, the air which flows along the outer surface of the A/C evaporator 93 is cooled by the heat exchange with the refrigerant. The refrigerant which passed through the passage inside the A/C evaporator 93 is again supplied to the compressor 31 through the third refrigerant passage 23, as illustrated by an arrow C3. On the other hand, the air which is cooled by flowing along the outer surface of the A/C evaporator 93 passes through the heater, and it is then supplied to the cabin of the vehicle 100.

### <Operation of Intake-Air Cooling System>

### (1) When Precooling Intake Evaporator

When the possibility that a knock of the engine 120 occurs is comparatively low, the intake-air cooling system 1 operates so as to precool the intake evaporator 35 prior to cooling of intake air. At this time, the compressor 31 is driven and the intake expansion valve 37 becomes in the opened state. Moreover, the damper D is located at the first position D1.

As described above, the damper D located at the first position D1 opens the first intake passage 131 but closes the second intake passage 132. Therefore, all the intake air which passed through the throttle valve 133 flows into the first intake passage 131, as illustrated by the arrow A1. The intake air which flows through the first intake passage 131 is supplied to the combustion chambers 121 of the engine 120, without being cooled.

The discharge pressure of the compressor 31 is determined based on an operating state of the air-conditioner 9 at this time. When the air-conditioner 9 operates along with the intake-air cooling system 1, the compressor 31 is driven so that the discharge pressure becomes larger than a case where the air-conditioner 9 does not operate.

All or a part of the refrigerant which flows through the second refrigerant passage 22 flows into the fourth refrigerant passage 24, as illustrated by an arrow C4. The refrigerant which flows through the fourth refrigerant passage 24 is then supplied to the intake expansion valve 37. The refrigerant expands when it passes through the intake expansion valve 37, and the temperature decreases.

The low-temperature refrigerant which passed through the intake expansion valve 37 is then supplied to the intake evaporator 35. The refrigerant cools the structure body of the intake evaporator 35, while flowing through the passage inside the intake evaporator 35. Since the intake air does not flow into the second intake passage 132, heat exchange between intake air and refrigerant is not performed in the intake evaporator 35. Therefore, the intake evaporator 35 is precooled promptly, and the temperature of the intake evaporator 35 decreases.

The refrigerant which passed through the passage inside the intake evaporator 35 is discharged by the fifth refrigerant passage 25. The refrigerant which flows through the fifth refrigerant passage 25 flows into the third refrigerant passage 23 as illustrated by an arrow C5, and it is supplied to the compressor 31.

### (2) When Cooling Intake Air

When a possibility that a knock of the engine 120 occurs becomes comparatively high, the intake-air cooling system 1 operates so as to cool the intake air. At this time, the compressor 31 is driven and the intake expansion valve 37 becomes in the opened state. Moreover, the damper D is located at the second position D2.

As described above, the damper D located at the second position D2 closes the first intake passage 131 but opens the second intake passage 132. Therefore, all the intake air which passed through the throttle valve 133 flows into the second intake passage 132, as illustrated by the arrow A2.

Since the intake evaporator 35 is precooled, the temperature of the intake evaporator 35 has already been comparatively low when the cooling of intake air is started. The refrigerant which passes through the intake expansion valve 37 and is supplied to the intake evaporator 35 evaporates by carrying out the heat exchange with the intake air which flows along the outer surface of the intake evaporator 35 in the second intake passage 132 when flowing through the passage inside the intake evaporator 35. The intake air which flows through the second intake passage 132 is cooled by the heat exchange with the refrigerant, and is supplied to the combustion chambers 121 of the engine 120.

### <Example of Operation of Intake-Air Cooling System and Air-Conditioner>

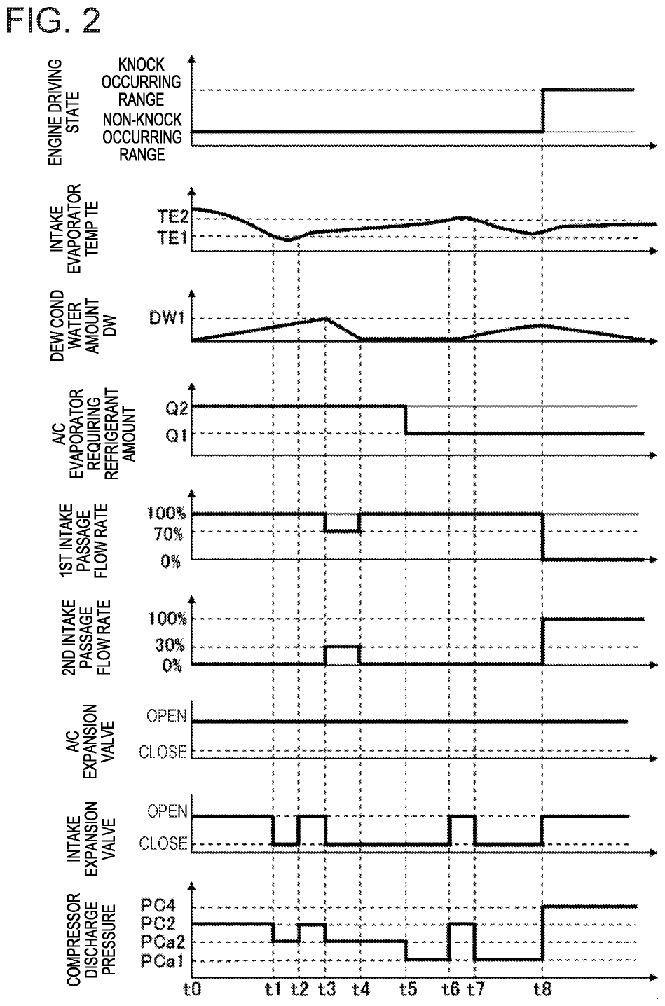

Next, one example of operation of the intake-air cooling system 1 and the air-conditioner 9 is described with reference to FIG. 2. FIG. 2 is a time chart illustrating one example of the operation of the intake-air cooling system 1 and the air-conditioner 9.

At time to, the driving state of the engine 120 belongs to the non-knock occurring range. The temperature TE of the intake evaporator 35 is higher than a threshold TE2, and the amount DW of dew condensation water adhering to the outer surface of the intake evaporator 35 is less than a threshold DW1. The threshold TE2 is an index for determining whether the intake evaporator 35 is sufficiently precooled. Moreover, the threshold DW1 is a value greater than zero, and is an index for determining whether the amount of dew condensation water is an amount which does not cause trouble for the engine 120 even if the dew condensation water flows into the combustion chamber 121.

In this case, the damper D is located at the first position D1, and all the intake air which passed through the throttle valve 133 flows into the first intake passage 131. Moreover, the compressor 31 is driven and the A/C expansion valve 97 becomes in the opened state. Therefore, the low-temperature refrigerant is supplied to the intake evaporator 35 and the intake evaporator 35 is precooled, thereby decreasing the temperature TE of the intake evaporator 35. According to the lowering of the temperature TE, the amount DW of dew condensation water increases.

Moreover, the air-conditioner 9 is instructed by the operator of the vehicle 100 to operate, and therefore, it becomes necessary to supply refrigerant to the A/C evaporator 93 at a flow rate Q2. Therefore, the A/C expansion valve 97 is also in the opened state, and the low-temperature refrigerant which passed through the A/C expansion valve 97 is supplied to the A/C evaporator 93. The discharge pressure of the compressor 31 at time t0 is set as PC2 at which the refrigerant can be supplied to the intake evaporator 35 and the A/C evaporator 93 at a sufficient flow rate.

At time t1, based on the temperature TE of the intake evaporator 35 becoming equal to or less than a threshold TE1, the intake expansion valve 37 shifts to the closed state from the opened state, and therefore, the discharge pressure of the compressor 31 decreases from PC2 to PCa2. The threshold TE1 is one example of a “given temperature” according to the present disclosure, and it is an index for determining whether the intake evaporator 35 is excessively precooled, and is less than the threshold TE2 described above. Moreover, the discharge pressure PCa2 corresponds to the flow rate Q2 of the refrigerant at which it needs to be supplied to the A/C evaporator 93. That is, based on the intake evaporator 35 being excessively precooled, the supply of the refrigerant to the intake evaporator 35 is suspended to reduce the discharge pressure of the compressor 31. Therefore, the drag which is applied to the engine 120 because of the precooling of the intake evaporator 35 can be suppressed.

At time t2, based on the temperature TE of the intake evaporator 35 becoming higher than the threshold TE1, the intake expansion valve 37 again shifts from the closed state to the opened state to increase the discharge pressure of the compressor 31 from PCa2 to PC2.

At time t3, based on the amount DW of dew condensation water becoming equal to or greater than the threshold DW1, the damper D is moved to a third position D3 (not illustrated). The third position D3 is located between the first position D1 and the second position D2. When the damper D is located at the third position D3, 70% of the intake air which passed through the throttle valve 133 flows into the first intake passage 131, and the remaining 30% flows into the second intake passage 132. The intake air which flowed into the second intake passage 132 removes the dew condensation water from the outer surface of the intake evaporator 35 when passing through the intake evaporator 35. The removed dew condensation water flows into the combustion chambers 121 of the engine 120 together with the intake air, and it is processed when the fuel combusts inside the combustion chambers 121. The removal of the dew condensation water by causing the intake air to flow into the second intake passage 132 is performed before time t4.

At time t5, based on the flow rate of the refrigerant which needs to be supplied to the A/C evaporator 93 being reduced from the flow rate Q2 to a flow rate Q1, the discharge pressure of the compressor 31 decreases from PCa2 to PCa1. The discharge pressure PCa1 corresponds to the flow rate Q1 of the refrigerant.

At time t6, based on the temperature TE of the intake evaporator 35 becoming higher than the threshold TE2, the intake expansion valve 37 shifts from the closed state to the opened state, and the discharge pressure of the compressor 31 increases from PCa1 to PC2. Therefore, the low-temperature refrigerant is again supplied to the intake evaporator 35, and the intake evaporator 35 is precooled.

At time t7, based on the temperature TE of the intake evaporator 35 becoming equal to or less than the threshold TE2, the intake expansion valve 37 again shifts to the closed state from the opened state, and the discharge pressure of the compressor 31 decreases from PC2 to PCa1.

At time t8, based on the driving state of the engine 120 shifting from the non-knock occurring range to the knock occurring range, the damper D is moved to the second position D2, and all the intake air which passed through the throttle valve 133 flows into the second intake passage 132. Moreover, the intake expansion valve 37 shifts from the closed state to the opened state, and the discharge pressure of the compressor 31 increases. The discharge pressure of the compressor 31 at this time is set as PC4 at which the refrigerant can be supplied to the intake evaporator 35 and the A/C evaporator 93 at a sufficient flow rate. Therefore, the intake air which flows through the second intake passage 132 is cooled by the heat exchange with the refrigerant in the intake evaporator 35, and is supplied to the combustion chambers 121 of the engine 120.

### <Processing Executed by Controller>

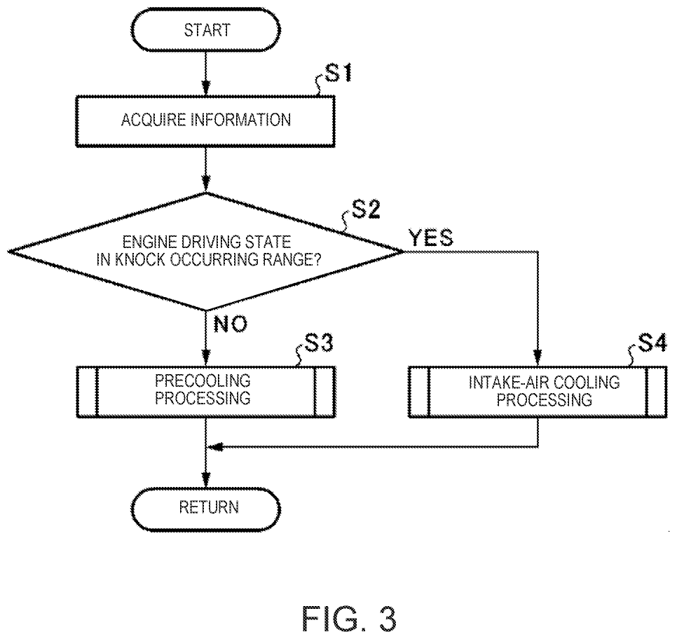

Next, processing executed by the controller 6 is described with reference to FIGS. 3 to 5. FIGS. 3 to 5 are flowcharts illustrating the processing executed by the controller 6.

First, the controller 6 acquires variety of information related to the vehicle 100 at Step S1 illustrated in FIG. 3. In detail, the controller 6 acquires, based on the information acquired from the sensors described above, the driving state of the engine 120, the temperature TE of the intake evaporator 35, and the amount DW of dew condensation water adhering to the outer surface of the intake evaporator 35, etc.

At Step S2, the controller 6 determines whether the driving state of the engine 120 at that moment belongs to the knock occurring range. If the controller 6 determines that the driving state of the engine 120 does not belong to the knock occurring range (i.e., if the cooling of intake air is not required) (S2: NO), it shifts to Step S3. Then, at Step S3, the controller 6 performs a precooling processing for precooling the intake evaporator 35.

On the other hand, if the controller 6 determines at Step S2 that the driving state of the engine 120 belongs to the knock occurring range (i.e., if the cooling of intake air is required) (S2: YES), it shifts to Step S4. Then, at Step S4, the controller 6 performs an intake-air cooling processing for cooling the intake air.

### <Precooling Processing>

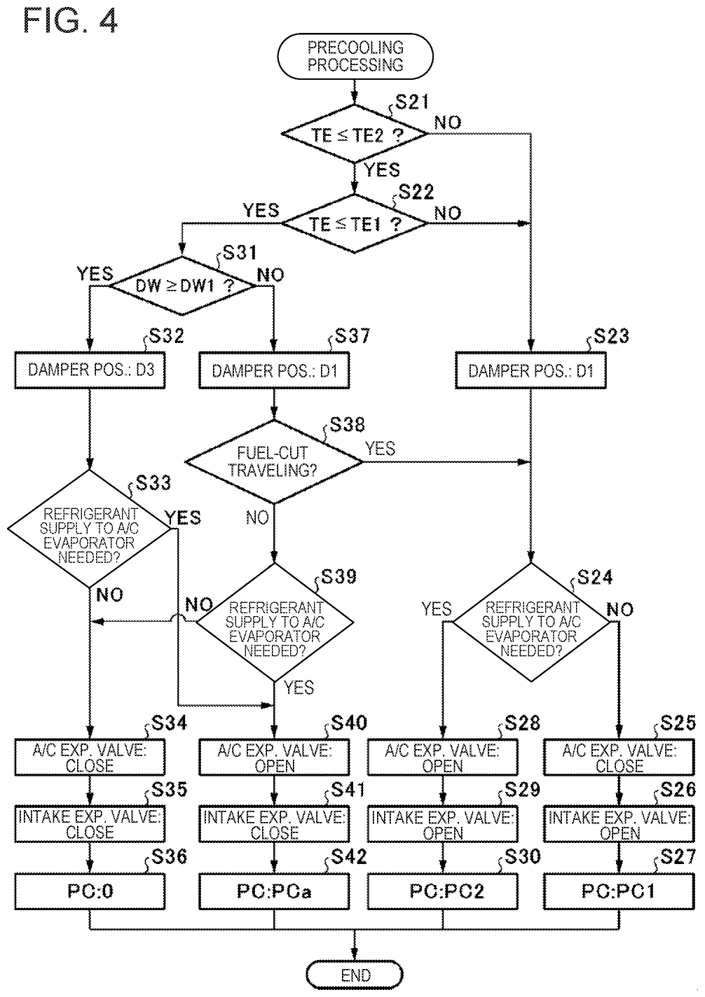

First, the precooling processing is described with reference to FIG. 4. FIG. 4 illustrates the precooling processing executed by the controller 6.

At Step S21, the controller 6 determines whether the temperature TE of the intake evaporator 35 is equal to or less than the threshold TE2. If the controller 6 does not determine that the temperature TE is equal to or less than the threshold TE2 (i.e., if the intake evaporator 35 is not precooled sufficiently) (S21: NO), it shifts to Step S23.

At Step S23, the controller 6 disposes the damper D at the first position D1. Therefore, all the intake air which passed through the throttle valve 133 flows into the first intake passage 131.

At Step S24, the controller 6 determines whether the refrigerant needs to be supplied to the A/C evaporator 93. If the controller 6 does not determine that the refrigerant needs to be supplied to the A/C evaporator 93 (S24: NO), it shifts to Step S25.

At Step S25, the controller 6 sets the A/C expansion valve 97 to the closed state, and, at Step S26, it sets the intake expansion valve 37 to the opened state. Moreover, at Step S27, the controller 6 sets the discharge pressure PC of the compressor 31 to PC1. Therefore, the refrigerant discharged from the compressor 31 is supplied to the intake evaporator 35 without being supplied the A/C evaporator 93, thereby performing the precooling of the intake evaporator 35.

On the other hand, if the controller 6 determines at Step S24 that the refrigerant needs to be supplied to the A/C evaporator 93 (S24: YES), it shifts to Step S28.

At Step S28, the controller 6 sets the A/C expansion valve 97 to the opened state, and, at Step S29, it sets the intake expansion valve 37 to the opened state. Moreover, at Step S30, the controller 6 sets the discharge pressure PC of the compressor 31 to PC2. PC2 is a value larger than PC1 (i.e., PC2>PC1). Therefore, the refrigerant discharged from the compressor 31 is supplied to the A/C evaporator 93 and the intake evaporator 35 so that the air which flows through the A/C passage 91 is cooled by the A/C evaporator 93, and the intake evaporator 35 is precooled.

On the other hand, if the controller 6 determines at Step S21 that the temperature TE of the intake evaporator 35 is equal to or less than the threshold TE2 (S21: YES), it shifts to Step S22.

At Step S22, the controller 6 determines whether the temperature TE is equal to or less than the threshold TEL If the controller 6 does not determine that the temperature TE is equal to or less than the threshold TE1 (i.e., if the intake evaporator 35 is not excessively precooled) (S22: NO), it shifts to Step S23. Then, the controller 6 performs the processings at Steps S23-S27, or Steps S23, S24, and S28-S30 to precool the intake evaporator 35.

On the other hand, if the controller 6 determines at Step S22 that the temperature TE is equal to or less than the threshold TE1 (S22: YES), it shifts to Step S31.

At Step S31, the controller 6 determines whether the amount DW of dew condensation water adhering to the outer surface of the intake evaporator 35 is equal to or greater than the threshold DW1. If the controller 6 determines that the amount DW of dew condensation water is equal to or greater than the threshold DW1 (S31: YES), it shifts to Step S32, where the dew condensation water is removed from the outer surface of the intake evaporator 35.

At Step S32, the controller 6 disposes the damper D at the third position D3. Therefore, 70% of the intake air which passed through the throttle valve 133 flows into the first intake passage 131, and the remaining 30% flows into the second intake passage 132. The dew condensation water is removed from the outer surface of the intake evaporator 35 by the intake air which flowed into the second intake passage 132.

At Step S33, the controller 6 determines whether the refrigerant needs to be supplied to the A/C evaporator 93. If the controller 6 does not determine that the refrigerant needs to be supplied to the A/C evaporator 93 (S33: NO), it shifts to Step S34.

At Step S34, the controller 6 sets the A/C expansion valve 97 to the closed state, and, at Step S35, it sets the intake expansion valve 37 to the closed state. Moreover, at Step S36, the controller 6 sets the discharge pressure PC of the compressor 31 as zero. That is, the compressor 31 is not driven. Therefore, since the refrigerant is not supplied to the intake evaporator 35, the increase in the amount DW of dew condensation water is suppressed.

On the other hand, if the controller 6 does not determine at Step S31 that the amount DW of dew condensation water adhering to the outer surface of the intake evaporator 35 is equal to or greater than the threshold DW1 (S31: NO), it shifts to Step S37.

At Step S37, the controller 6 disposes the damper D at the first position D1. Therefore, all the intake air which passed through the throttle valve 133 flows into the first intake passage 131.

At Step S38, the controller 6 determines whether the vehicle 100 is in a fuel-cut traveling state. In detail, the controller 6 determines whether the supply of fuel to the combustion chambers 121 of the engine 120 is inhibited, and the vehicle 100 travels only by inertia. If the vehicle 100 is in the fuel-cut traveling state, the rotation of the wheels of the vehicle 100 is transmitted from the output shaft of the engine 120 to the compressor 31 through the powertrain. As a result, the compressor 31 can be driven using kinetic energy of the inertia traveling of the vehicle 100 to precool the intake evaporator 35. That is, it becomes possible using the kinetic energy of the vehicle 100 to precool the intake evaporator 35. Therefore, if the controller 6 determines that the vehicle 100 travels in the fuel-cut state (S38: YES), it shifts to Step S24. Then, the controller 6 performs the processing at Steps S24-S27, or Steps S24 and S28-S30 to precool the intake evaporator 35.

On the other hand, if the controller 6 does not determine at Step S38 that the vehicle 100 travels in the fuel-cut state (S38: NO), it shifts to Step S39.

At Step S39, the controller 6 determines whether the refrigerant needs to be supplied to the A/C evaporator 93. If the controller 6 determines that the refrigerant needs to be supplied to the A/C evaporator 93 (S39: YES), it shifts to Step S40.

At Step S40, the controller 6 sets the A/C expansion valve 97 to the opened state, and, at Step S41, it sets the intake expansion valve 37 to the closed state. Moreover, at Step S42, the controller 6 sets the discharge pressure PC of the compressor 31 to PCa. The discharge pressure PCa corresponds to a flow rate of the refrigerant which needs to be supplied to the A/C evaporator 93. Therefore, the refrigerant discharged from the compressor 31 is supplied to the A/C evaporator 93, without being supplied to the intake evaporator 35, and the air which flows through the A/C passage 91 is cooled by the A/C evaporator 93.

On the other hand, if the controller 6 does not determine at Step S39 that the refrigerant needs to be supplied to the A/C evaporator 93 (S39: NO), it shifts to Step S34. Then, the controller 6 performs the processing at Steps S34-S36.

### <Intake-Air Cooling Processing>

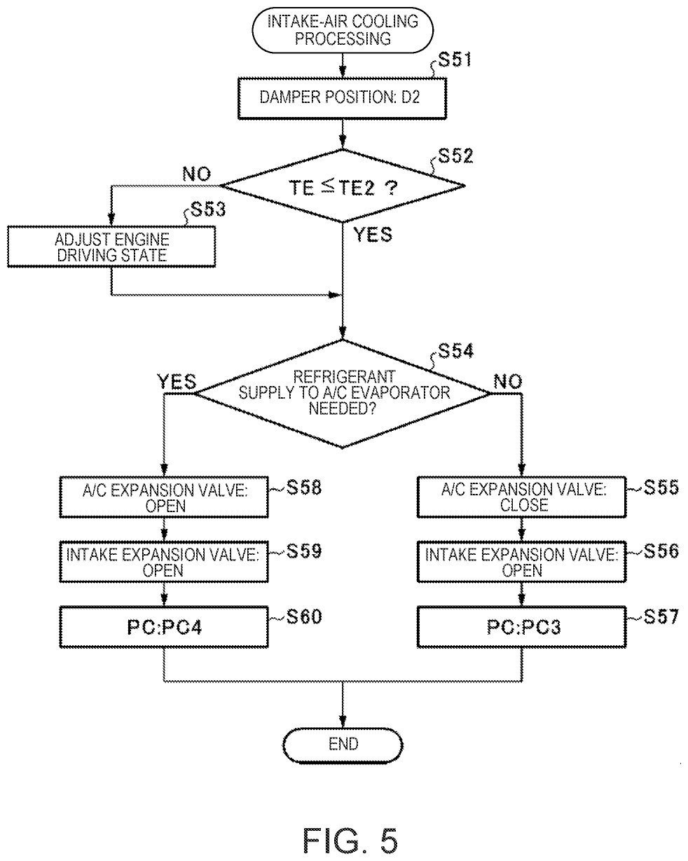

Next, the intake-air cooling processing is described with reference to FIG. 5. FIG. 5 illustrates the intake-air cooling processing executed by the controller 6.

First, at Step S51, the controller 6 disposes the damper D at the second position D2. Therefore, all the intake air which passed through the throttle valve 133 flows into the second intake passage 132. The intake air which flowed into the second intake passage 132 is cooled by the heat exchange with the intake evaporator 35 which is precooled until then, and is supplied to the combustion chambers 121 of the engine 120.

At Step S52, the controller 6 determines whether the temperature TE of the intake evaporator 35 is equal to or less than the threshold TE2. If the controller 6 determines that the temperature TE is equal to or less than the threshold TE2 (i.e., if the intake evaporator 35 is sufficiently precooled) (S52: YES), it shifts to Step S54.

On the other hand, if the controller 6 does not determine at Step S52 that the temperature TE of the intake evaporator 35 is equal to or less than the threshold TE2 (S52: NO), it shifts to Step S53. At Step S53, the controller 6 adjusts the driving state of the engine 120 so that the engine 120 is driven outside the knock occurring range. For example, the controller 6 adjusts an injection timing of fuel from the injector to the combustion chamber 121. The controller 6 shifts to Step S54 after the execution of the processing at Step S53.

At Step S54, the controller 6 determines whether the refrigerant needs to be supplied to the A/C evaporator 93. If the controller 6 does not determine that the refrigerant needs to be supplied to the A/C evaporator 93 (S54: NO), it shifts to Step S55.

At Step S55, the controller 6 sets the A/C expansion valve 97 to the closed state, and, at Step S56, it sets the intake expansion valve 37 to the opened state. Moreover, at Step S57, the controller 6 sets the discharge pressure PC of the compressor 31 to PC3. PC3 is a value greater than PC1 and PC2 (i.e., PC3>PC2>PC1). Therefore, the refrigerant discharged from the compressor 31 is supplied to the intake evaporator 35, without being supplied to the A/C evaporator 93. The intake air which flows into the second intake passage 132 and flows along the outer surface of the intake evaporator 35 is cooled by the heat exchange with the refrigerant, and it is supplied to the combustion chambers 121 of the engine 120.

On the other hand, if the controller 6 determines at Step S54 that the refrigerant needs to be supplied to the A/C evaporator 93 (S54: YES), it shifts to Step S58.

At Step S58, the controller 6 sets the A/C expansion valve 97 to the opened state, and, at Step S59, it sets the intake expansion valve 37 to the opened state. Moreover, at Step S60, the controller 6 sets the discharge pressure PC of the compressor 31 to PC4. PC4 is a value greater than PC3 (i.e., PC4>PC3>PC2>PC1). Therefore, the refrigerant discharged from the compressor 31 is supplied to the A/C evaporator 93 and the intake evaporator 35, the air which flows through the A/C passage 91 is cooled by the A/C evaporator 93, and the intake air which flows through the second intake passage 132 is cooled by the intake evaporator 35.

### <Operation and Effects>

According to the above configuration, the intake evaporator 35 is provided to the second intake passage 132 among the first intake passage 131 and the second intake passage 132 which supply air to the combustion chambers 121 of the engine 120. Further, when the driving state of the engine 120 does not belong to the knock occurring range (i.e., when the cooling of intake air is not required), the refrigerant discharged from the compressor 31 is supplied to the intake evaporator 35 to precool the intake evaporator 35.

At this time, since a ratio of the flow rate of the air which flows into the second intake passage 132 is smaller than that when the driving state of the engine 120 belongs to the knock occurring range (i.e., when the cooling of intake air is required), the heat exchange between the refrigerant and the air in the intake evaporator 35 becomes slower. Therefore, only by supplying the refrigerant to the intake evaporator 35 at a comparatively small flow rate, the intake evaporator can be precooled to maintain the precooled state. As a result, it becomes possible to suppress the drag applied to the engine 120 because of the precooling of the intake evaporator 35.

Moreover, the controller 6 acquires the temperature TE of the intake evaporator 35 and the temperature TA of the air around the intake evaporator 35, and estimates the amount DW of dew condensation water adhering to the outer surface of the intake evaporator 35. Moreover, when the controller 6 determines that the amount DW of dew condensation water is equal to or greater than the threshold DW1, it controls the damper D so that the ratio of the flow rate of the air which flows into the second intake passage 132 becomes larger than a case where it does not determine that the amount DW of dew condensation water is greater than or equal to the threshold DW1.

According to the heat exchange in the intake evaporator 35, the dew condensation water may adhere to the outer surface of the intake evaporator 35, and the dew condensation water may flow into the combustion chamber 121 of the engine 120 along with air. If the amount of dew condensation water which flows into the combustion chamber 121 at once is small, since the dew condensation water evaporates in the combustion chamber 121 and is discharged, it will not cause trouble to the engine 120. However, if a large amount of dew condensation water flows into the combustion chamber 121 at once, the water hammer phenomenon occurs, which may lead to damage to the engine 120.

Therefore, according to the above configuration, when it is determined that the amount of dew condensation water adhering to the outer surface of the intake evaporator 35 is equal to or greater than the threshold DW1, the ratio of the flow rate of the air which flows into the second intake passage 132 is relatively increased. When the threshold DW1 is set as the amount of dew condensation water which does not cause trouble to the engine 120 even if the dew condensation water flows into the combustion chambers 121 at once, it becomes possible to process the dew condensation water safely by positively causing the dew condensation water to flow into the combustion chambers 121 due to the air which flows through the second intake passage 132 at the comparatively high flow rate. That is, it becomes possible to prevent the damage to the engine 120 by processing the dew condensation water while the amount of dew condensation water is comparatively small.

Moreover, when the temperature TE of the intake evaporator 35 is the threshold TE1 or less and the fuel is supplied to the combustion chambers 121 of the engine 120, the controller 6 controls the compressor 31 so that the flow rate of the refrigerant supplied to the intake evaporator 35 reaches zero (first flow rate). Moreover, when the temperature TE of the intake evaporator 35 is equal to or less than the threshold TE1, and the vehicle 100 travels without the fuel being supplied to the combustion chambers 121 of the engine 120, the compressor 31 is controlled so that the flow rate of the refrigerant supplied to the intake evaporator 35 reaches a flow rate (second flow rate) larger than zero (first flow rate).

According to the above configuration, when the temperature TE of the intake evaporator 35 is equal to or less than the threshold TE1, and the fuel is supplied to the combustion chambers 121 of the engine 120, it becomes possible to suppress the drag applied to the engine 120 by relatively reducing the flow rate of the refrigerant supplied to the intake evaporator 35 and suppressing the excessive precooling of the intake evaporator 35. In this case “the flow rate of the refrigerant supplied to the intake evaporator 35” is a value including zero.

On the other hand, when the vehicle 100 travels without the fuel being supplied to the combustion chambers 121 of the engine 120 (i.e., when the vehicle 100 travels only by inertia), it is possible to drive the compressor 31 coupled to the output shaft of the engine 120 by using the kinetic energy of the vehicle 100. Therefore, in this case, even if the temperature TE of the intake evaporator 35 is equal to or less than the threshold TE1, it becomes possible to precool the intake evaporator 35 sufficiently by using the kinetic energy of the vehicle 100 and relatively increasing the flow rate of the refrigerant supplied to the intake evaporator 35.

The embodiment described above is for facilitating understandings of the present disclosure, and is not intended to limit the present disclosure. Each element provided to the above embodiment, and its arrangement, material, condition, shape, and size are not necessarily limited to what is illustrated, and they may suitably be changed.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

DESCRIPTION OF REFERENCE CHARACTERS

| | |
|---|---|
| 1 | Intake-air Cooling System |
| 31 | Compressor |
| 35 | Intake Evaporator (Evaporator) |
| 6 | Controller |
| 100 | Vehicle |
| 120 | Engine |
| 121 | Combustion Chamber |
| 130a | Intake Passage |
| 131 | First Intake Passage |
| 132 | Second Intake Passage |
| D | Damper |

What is claimed is:

1. An intake-air cooling system configured to cool intake air of an engine of a vehicle, comprising:
an intake passage configured to supply air to a combustion chamber of the engine;
a compressor coupled to an output shaft of the engine and configured to be driven by rotation of the output shaft to discharge refrigerant;
an evaporator provided to the intake passage and configured to exchange heat between the refrigerant supplied from the compressor and the air flowing through the intake passage to cool the air; and
a controller configured to determine whether a driving state of the engine belongs to a knock occurring range where a knock tends to occur, and control the compressor,
wherein the intake passage branches to a first intake passage and a second intake passage, and is provided with a damper configured to change a ratio between a flow rate of air flowing into the first intake passage and a flow rate of air flowing into the second intake passage,
wherein the evaporator is provided to the second intake passage and cools the air flowing through the second intake passage, and
wherein when the controller does not determine that the driving state of the engine belongs to the knock occurring range, the controller controls the compressor so that a flow rate of the refrigerant supplied to the evaporator becomes smaller within a range larger than zero, and controls the damper so that the ratio of the flow rate of the air flowing into the second intake passage becomes smaller than in a case where the controller determines that the driving state of the engine belongs to the knock occurring range.

2. The intake-air cooling system of claim 1,
wherein the controller acquires a temperature of the evaporator and a temperature of air around the evaporator and estimates an amount of dew condensation water adhering to an outer surface of the evaporator, and
wherein if the controller determines that the amount of dew condensation water is equal to or greater than a given amount, the controller controls the damper so that the ratio of the flow rate of the air flowing into the second intake passage becomes larger than a case where the controller does not determine that the amount of dew condensation water is equal to or greater than the given amount.

3. The intake-air cooling system of claim 2,
wherein, when the temperature of the evaporator is equal to or less than a given temperature and fuel is supplied to the combustion chamber of the engine, the controller controls the compressor so that the flow rate of the refrigerant supplied to the evaporator reaches a first flow rate, and
wherein, when the temperature of the evaporator is equal to or less than the given temperature and the vehicle travels without the fuel being supplied to the combustion chamber of the engine, the controller controls the compressor so that the flow rate of the refrigerant supplied to the evaporator reaches a second flow rate larger than the first flow rate.

4. The intake-air cooling system of claim 1, wherein the damper is an instrument configured to change the directivity of the intake air, and is controlled, by an actuator configured to be driven based on a control signal, so that the damper pivots to a position between a first position and a second position.

5. The intake-air cooling system of claim 4,
wherein when the damper is located at the first position, the first intake passage is opened and the second intake passage is closed by the damper, and
wherein when the damper is located at the second position, the first intake passage is closed and the second intake passage is opened by the damper.

6. The intake-air cooling system of claim 4, wherein when the controller does not determine that the driving state of the engine belongs to the knock occurring range, the damper is disposed at the first position.

7. The intake-air cooling system of claim 4, wherein when the controller determines that the driving state of the engine belongs to the knock occurring range, the damper is disposed at the second position.

8. The intake-air cooling system of claim 6, wherein when the controller determines that the driving state of the engine belongs to the knock occurring range, the damper is disposed at the second position.
